(19) United States
(12) Patent Application Publication
(10) Pub. No.: US 2025/0118105 A1
(43) Pub. Date: Apr. 10, 2025

(54) REACTION SENSING SYSTEM AND METHOD FOR DISPLAYING REACTION SENSING RESULT

(71) Applicant: Panasonic Intellectual Property Management Co., Ltd., Osaka (JP)

(72) Inventors: Sonoko HIRASAWA, Kanagawa (JP); Koji HORIUCHI, Fukuoka (JP); Takeshi YOSHIHARA, Fukuoka (JP)

(73) Assignee: Panasonic Intellectual Property Management Co., Ltd., Osaka (JP)

(21) Appl. No.: 18/714,489

(22) PCT Filed: Nov. 17, 2022
(86) PCT No.: PCT/JP2022/042720

§ 371 Date: May 29, 2024

(30) Foreign Application Priority Data
Dec. 3, 2021 (JP) 2021-196799

(51) Int. Cl. G06V 40/16; G06T 11/20

(52) U.S. Cl. CPC G06V 40/174; G06T 11/206

(57) ABSTRACT

Provided is a system or method configured to present reactions exhibited by participants in an online event to users such that individual participants are not identified, thereby preventing the participants from being conscious that their reactions are being sensed, and thus enabling them to naturally exhibit their reactions, which allows the users to acquire information on the participants' naturally-exhibited reactions. The system includes a user terminal provided with a camera; and an analysis server configured to acquire camera images of each participant from the terminal device, and perform a reaction sensing operation to sense reactions exhibited by the each participant based on the camera images. The analysis server aggregates results of the reaction sensing operation for all the participants to thereby generate reaction information on the all the participant's reactions (e.g., level information and proportion information), and generates display information that visualizes the reaction information.

### TECHNICAL FIELD

The present disclosure relates to a reaction sensing system and a method for displaying reaction sensing result, configured to sense reactions exhibited by participants in an online event, visualize results of sensing, and display the visualized results of sensing.

### BACKGROUND ART

In recent years, online meeting systems have become widely used for holding presentations and other meetings online. In such online meeting systems, camera images of a host and guest participants are displayed on screens, and documents shared between the host (or presenter) and the participants are also displayed on the screens. However, these systems have a problem that reactions exhibited by the participants in the online meetings are not conveyed to the host and participants with vivid reality as if they were present in a site.

As a solution to the problem of such online meeting systems, there is a known technology that allows participants to enter their impressions of what is presented at an online meeting, and the entered impressions are aggregated and displayed (Patent Document 1). Another known technology is a device configured to detect nodding motions of participants through image recognition on camera images of the participants and display information on the number and frequency of nodding motions of each participant on the participants' terminals (Patent Document 2).

### PRIOR ART DOCUMENT(S)

### Patent Document(s)

Patent Document 1: JP2021-036640A
Patent Document 1: JP2009-267621A

### SUMMARY OF THE INVENTION

### Task to be Accomplished by the Invention

In the prior-art technology disclosed in Patent Document D1, since participants themselves enter their reaction information, the entered information does not always information on actual reactions exhibited by the participants. In the prior-art technology disclosed in Patent Document D2, a device detects nodding motions of participants through image recognition on camera images of the participants, which enables the device to acquire information on actual reactions exhibited by the participant. However, in this technology, since participants' reaction information is displayed in a manner that each individual participant is identified, the participants are conscious that their reactions are being sensed during an online event, which causes a problem of failure to acquire information on the participants' naturally-exhibited reactions.

The present disclosure has been made in view of such problems of the prior art, and a primary object of the present disclosure is to provide a reaction sensing system and a method for displaying reaction sensing result configured to present reactions exhibited by participants in an online event to users such that individual participants are not identified, thereby preventing the participants from being conscious that their reactions are being sensed, and thus enabling them to naturally exhibit their reactions, which allows the users to acquire information on the participants' naturally-exhibited reactions.

### Means to Accomplish the Task

An aspect of the present disclosure provides a reaction sensing system configured to sense reactions exhibited by participants in an online event, visualize results of sensing, and display the visualized results of sensing, the system comprising: a terminal device having a camera for shooting each of the participants; and a server device configured to acquire camera images of each participant from the terminal device, perform a reaction sensing operation to sense reactions exhibited by the each participant based on the acquired camera images, and generate display information that visualizes results of the reaction sensing operation, wherein the server device generates reaction information on reactions exhibited by all the participants by aggregating the respective results of the reaction sensing operation for all the participants, and generates the display information that visualizes the reaction information.

Another aspect of the present disclosure provides a method for displaying reaction sensing result by sensing reactions exhibited by participants in an online event, visualizing results of sensing, and displaying the visualized results of sensing, the method comprising: acquiring camera images of each participant from a terminal device having a camera, the camera images being shot by the camera; performing a reaction sensing operation to sense reactions exhibited by the each participant based on the acquired camera images; generating reaction information on reactions exhibited by all the participants by aggregating the respective results of the reaction sensing operation for all the participants; and generates display information that visualizes the reaction information.

### Effect of the Invention

According to the present disclosure, display information; that is, visualized reaction information on reactions exhibited by all participants in an online event is presented to users such as participants. As information on reactions exhibited by all the participants is presented to users such that individual participants are not identified, the participants are prevented from being conscious that their reactions are being sensed, which allows the users to acquire information on the participants' naturally-exhibited reactions.

### BRIEF DESCRIPTION OF THE DRAWINGS

FIG. 1 is a diagram showing an overall configuration of a reaction sensing system according to one embodiment of the present disclosure;

FIG. 2 is an explanatory diagram showing a presentation screen displayed on a user terminal of a participant;

FIG. 3 is an explanatory diagram showing a presentation screen displayed on a user terminal of a participant;

FIG. 4 is an explanatory diagram showing an after-event analysis result screen displayed on a user terminal of a host;

FIG. 5 is an explanatory diagram showing a presentation screen displayed on a user terminal of a host;

FIG. 6 is an explanatory diagram showing a presentation screen displayed on a user terminal of a host;

FIG. 7 is a block diagram showing a schematic configuration of an analysis server;

FIG. 8 is a block diagram showing an outline of operations performed by the analysis server;

FIG. 9 is an explanatory diagram showing registered information contained in a document DB and a reaction DB, both being managed by the analysis server;

FIG. 10 is a flow chart showing a procedure of a real-time reaction sensing operation performed by the analysis server;

FIG. 11 is a flow chart showing a procedure of a real-time reaction analysis operation performed by the analysis server;

FIG. 12 is a flow chart showing a procedure of an after-event reaction analysis operation performed by the analysis server; and

FIG. 13 is a flow chart showing a procedure of an information management operation for the document DB.

### DESCRIPTION OF THE PREFERRED EMBODIMENT(S)

A first aspect of the present disclosure made to achieve the above-described object is a reaction sensing system configured to sense reactions exhibited by participants in an online event, visualize results of sensing, and display the visualized results of sensing, the system comprising: a terminal device having a camera for shooting each of the participants; and a server device configured to acquire camera images of each participant from the terminal device, perform a reaction sensing operation to sense reactions exhibited by the each participant based on the acquired camera images, and generates display information that visualizes results of the reaction sensing operation, wherein the server device generates reaction information on reactions exhibited by all the participants by aggregating the respective results of the reaction sensing operation for all the participants, and generates the display information that visualizes the reaction information.

In this configuration, display information; that is, visualized reaction information on reactions exhibited by all participants in an online event is presented to users such as participants. As information on reactions exhibited by all the participants is presented to users such that individual participants are not identified, the participants are prevented from being conscious that their reactions are being sensed, which allows the users to acquire information on the participants' naturally-exhibited reactions.

A second aspect of the present disclosure is the system of the first aspect, wherein the server device generates the display information based on the respective results of the reaction sensing operation for the participants, the respective results of the reaction sensing operation being provided on a real time basis.

This configuration enables the users (e.g., participants) to feel a mood of the event with vivid reality as if they were physically present in a site.

A third aspect of the present disclosure is the system of the second aspect, wherein the server device generates, as the reaction information, level information indicating a percentage of positive or negative reactions exhibited by all the participants.

This configuration enables the users to easily grasp the percentage of positive or negative reactions exhibited by participants to the reactions of all the participants.

A fourth aspect of the present disclosure is the system of the second aspect, wherein the server device generates, as the reaction information, proportion information indicating proportions of the respective numbers of participants exhibiting different types of reactions to that of all the participants.

This configuration enables the users to easily grasp proportions of the respective numbers of participants exhibiting different types of reactions to that of all the participants.

A fifth aspect of the present disclosure is the system of the second aspect, wherein, after the online event is finished, the server device generates, as the reaction information, a graph indicating how the reactions exhibited by the participants change across different stages of the online event.

This configuration enables the users to easily grasp how the reactions exhibited by the participants change across different stages of the online event. For example, when the online event is a presentation, the system is enabled to generate a graph indicating how audience's reactions change across a presenter's commentary times (page display times) for different pages of the presentation material.

A sixth aspect of the present disclosure is the system of the first aspect, wherein the server device generates, as the results of the reaction sensing operation, results of determination of which type of reaction is exhibited by the each participant: among the types of reactions indicating a focused state of mind, a tired state of mind, a satisfied state of mind, a dissatisfied state of mind, and a questioning state of mind. (A reaction type of the questioning state of mind is a reaction of a participant when there is anything the participant does not understand or the participant has a question.)

In this configuration, the system is enabled to appropriately typify reactions exhibited by participants in the online event.

A seventh aspect of the present disclosure is a method for displaying reaction sensing result by sensing reactions exhibited by participants in an online event, visualizing results of sensing, and displaying the visualized results of sensing, the method comprising: acquiring camera images of each participant from a terminal device having a camera, the camera images being shot by the camera; performing a reaction sensing operation to sense reactions exhibited by the each participant based on the acquired camera images; generating reaction information on reactions exhibited by all the participants by aggregating the respective results of the reaction sensing operation for all the participants; and generates display information that visualizes the reaction information.

In this configuration, as is the case with the first aspect, as information on reactions exhibited by all the participants is presented to users such that individual participants are not identified, the participants are prevented from being conscious that their reactions are being sensed, which allows the users to acquire information on the participants' naturally-exhibited reactions.

Embodiments of the present disclosure will be described below with reference to the drawings.

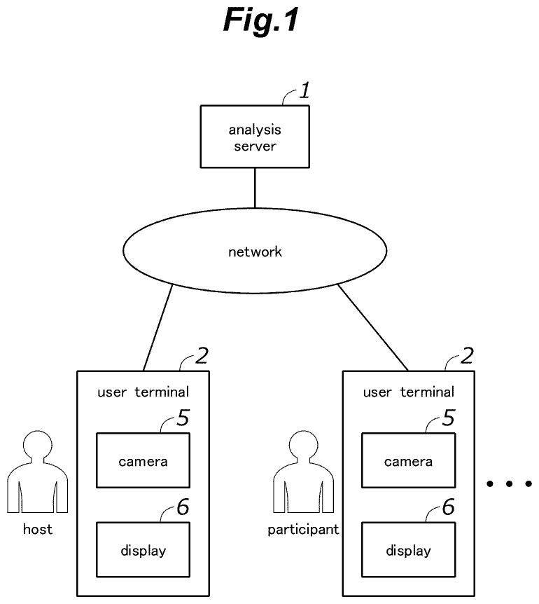

FIG. 1 is a diagram showing an overall configuration of e a reaction sensing system according to one embodiment of the present disclosure.

This system is configured to perform a reaction sensing operation to sense reactions shown by participants in an online meeting (online event), visualize results of the reaction sensing operation (reaction sensing operation results), and present the visualized results to the participants and a host. The system has an analysis server 1 (server device, information processing device) and user terminals 2 (terminal devices) configured to be operated by the host and participants. The analysis server 1 is connected to the user terminals 2 via a network.

The analysis server 1 is configured to acquire camera images of participants from the participants' user terminals 2, perform an image analysis operation on camera images, perform a reaction sensing operation to sense reactions shown by the participants, and generate visual display information indicating results of the reaction sensing operation. The generated visual display information is transmitted to the user terminals 2 and displayed on their screens.

A user terminal 2 is equipped with a camera 5 for capturing images (camera images) of participants and a display 6 for displaying screen data delivered from the analysis server 1. A participant's user terminal 2 transmits camera images of the participant captured by camera 5 to the analysis server 1. A user terminal 2 used by a host (presenter) also transmits camera images of the host captured by the camera 5 to the analysis server 1 as necessary. A user terminal 2 receives display information indicating visualized reaction sensing operation results transmitted from the analysis server 1 and displays the results on the screen.

In the present embodiment, the online event is a meeting, in particular, a presentation. However, the online event is not limited to meetings, and may be, for example, a lecture session, a training session, or an online lesson.

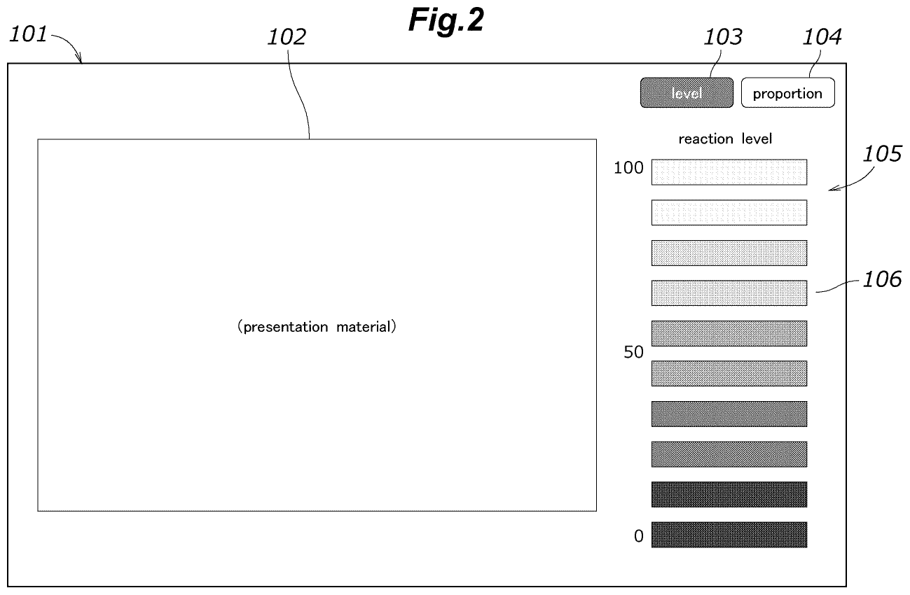

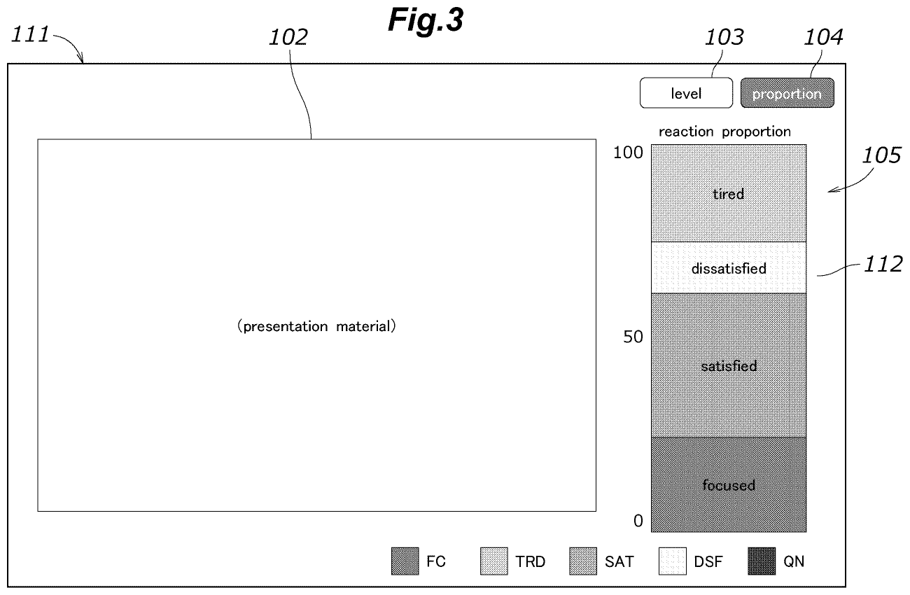

Next, presentation screens 101, 111 displayed on a user terminal 2 of a participant will be described. FIGS. 2 and 3 are explanatory diagrams showing presentation screens 101, 111 displayed on a user terminal 2 of a participant.

The presentation screens 101 and 111 (FIGS. 2 and 3) are displayed on a participant's user terminals 2 during an online meeting (presentation).

The presentation screens 101 and 111 each have a document display section 102. A presentation material(s) is displayed on the document display section 102. A host uploads the presentation material(s) before the online meeting from the host's (presenter's) user terminal 2 to the analysis server 1 so that the presentation material(s) can be delivered to each participant's user terminal 2. As a result, the presentation material(s) is displayed on the host's user terminal 2 and the each participant's user terminal 2; that is, the host and the participants share the presentation material(s). The analysis server 1 may be configured to deliver the presentation screens 101, 111 to each user's user terminal in cooperation with a management server used for the online meeting (not shown) and with an application for online meeting installed in the user terminal 2.

The presentation screens 101 and 111 each include a level button 103 and a proportion button 104. When a participant operates the level button 103, the presentation screen 101 transitions to the presentation screen 101 in a level display mode (FIG. 2). When the participant operates the proportion button 104, the screen transitions to the presentation screen 111 in a proportion display mode (FIG. 3).

The presentation screens 101 and 111 each include an analysis result display section 105. The analysis result display section 105 displays the status of reactions shown by all the participants on a real-time basis. What is displayed in the analysis result display section 105 varies depending on the display mode (the level display mode and proportion display mode).

What is displayed in the analysis result display section 105 is updated when a real-time reaction sensing operation and a real-time reaction analysis operation are performed in a predetermined cycle (e.g., one second, three seconds, or five seconds). As a result, what is displayed in the analysis result display section 105 changes from time to time as the presentation progresses. This allows participants to grasp the reactions shown by all the participants at a glance and feel a mood of the event with vivid reality as if they were physically present in a site.

In the presentation screen 101 in level display mode (FIG. 2), the analysis result display section 105 shows an image 106 representing a reaction level (level information), which indicates the proportion of participants showing positive reactions to all the participants. A reaction level is represented by the percentage of participants showing positive reactions. The image 106 indicating a reaction level consists of multiple bars arranged in a column, with the reaction level being indicated by the number of bars lighting in successive order from the bottom one. The bars may light up in different colors, for example, gray, blue, green, yellow, and red, in ascending order of level.

The reaction level allows a participant to grasp the proportion of participants showing positive reactions in all the participants. For example, when the reaction level is high, a participant can understand that many participants show positive reactions; that is, the mood of the online meeting is lively. When the reaction level is low, a participant can know that a rather small number of participants show positive reactions; that is, the online meeting is not lively. In the latter case, a participant can boost the online meeting e.g., by asking questions.

In the presentation screen 111 (FIG. 3) in the proportion display mode, the analysis result display section 105 shows an image 112 representing reaction proportions (proportion information), which indicate proportions of different types of reactions shown by participants to the reactions of all the participants. In the reaction proportion image 112, a 100% stacked column chart shows the part-to-whole proportions of different types of reactions. The types of reactions consist of reactions indicating a focused state of mind (FC type reaction), a tired state of mind (TR type reaction), a satisfied state of mind (ST type reaction), a dissatisfied state of mind (DSF type reaction), and a questioning state of mind (QN type reaction), the QN type reaction being a reaction of a participant when there is anything the participant does not understand or the participant has a question. The column's parts for these reaction types light up in different colors.

The reaction proportions allow a participant to grasp what type of reaction is shown by many participants. When many participants show reactions of the FC type and TR type, a participant can liven the online meeting e.g., by asking questions or chatting.

The presentation screens 101 and 111 (FIGS. 2 and 3) are displayed on each participant's user terminals 2, and similar screens may be displayed on the host's (presenter's) user terminal 2. This allows the host to grasp the proportion of participants showing positive reactions to all the participants and which types of reactions are shown by a major part of participants. Referring to these screens, the host (presenter) can boost the mood of the online meeting as necessary, e.g., by changing the development of the online meeting, asking questions, or chatting with participants.

In the present embodiment, the presentation screen 101 (FIG. 2) in the level display mode shows the reaction level indicating the percentage of participants showing positive reactions to all the participants. The term “positive reactions” refers to reactions of the FC type and ST type. The presentation screen may show the reaction level indicating the percentage of participants showing negative reactions to all the participants. The term “negative reactions” refers to reactions of the TRD type, DIS type, and QN type. In some cases, a user (participant or host) may be allowed to designate a reaction type(s) (FC type, TR type, ST type, DSF type or QN type) through a reaction level setting screen (not shown), so that the presentation screen shows the reaction level indicating the percentage of reactions of the type(s) designated by the user.

In the present embodiment, the presentation screen 111 (FIG. 3) in the proportion display mode shows a reaction proportion for each type (FC type, TR type, ST type, DSF type or QN type) of reactions. However, a type of reaction that cannot be classified to any of positive and negative reactions may be defined as a “neutral reaction” and the presentation screen 111 may indicate the respective percentages of the positive, negative, and neutral reactions.

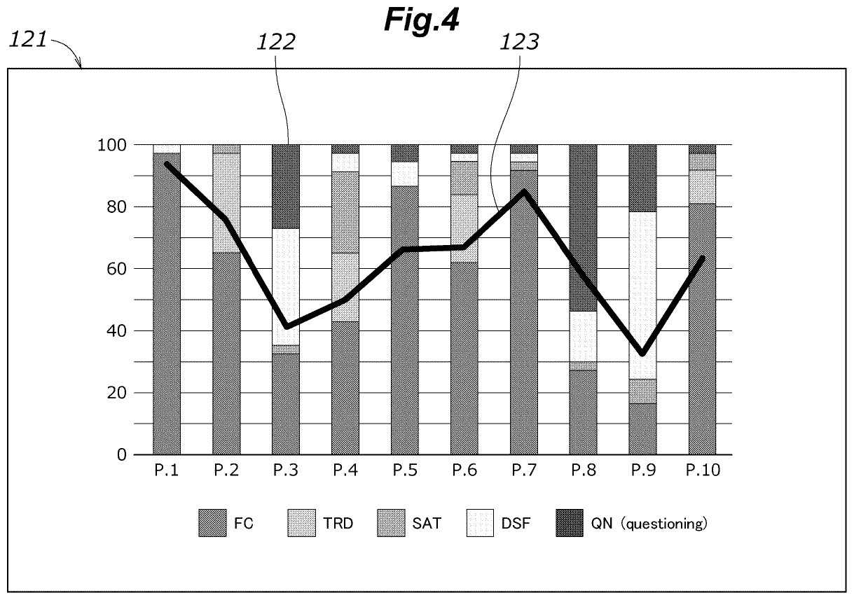

Next, an after-event analysis result screen 121 displayed on a user terminal of a host will be described. FIG. 4 is an explanatory diagram showing an after-event analysis result screen 121 displayed on a user terminal of a host.

The host's user terminal 2 displays the after-event analysis result screen 121 after an online meeting (presentation) is finished.

The after-event analysis result screen 121 displays bar graphs 122 and a line graph 123 representing the results of an after-event reaction analysis operation. The bar graphs 122 and the line graph 123 represent how the participants' reactions change across the respective stages of the online meeting. Specifically, a “stage” of an online meeting (presentation) corresponds to a page display time; that is, a time during which each page (slide) of a presentation material is displayed and explained by a presenter, and the bar graphs 122 and the line graph 123 represent what types of reactions are shown by participants in each page display time, during which a corresponding page of the presentation material displayed and explained by a presenter.

As is the case with the image 112 of the reaction proportions displayed in the analysis result display section 105 of the presentation screen 111 (FIG. 3) in the proportion display mode, the bar graphs 122 show 100% stacked bar graphs for respective pages, each indicating proportions of different types of reactions shown by participants to the reactions of the all the participants. This allows a user (e.g., host) to grasp what types of reactions are shown by many participants for each page display time, during which a corresponding page is displayed and explained by a presenter.

As is the case with the reaction level image 106 displayed in the analysis result display section 105 of the presentation screen 101 (FIG. 2) in level display mode, the line graph 123 indicates the reaction levels for respective pages, each level representing the proportion of participants showing positive reactions in all the participants for a corresponding page. This allows a user (e.g., presenter) to grasp the percentage of participants showing positive reactions in all the participants during each page of the presentation material is displayed and explained. A reaction level may be defined to indicate the percentage of participants showing negative reactions to all the participants.

The after-event analysis result screen 121 allows a user (e.g., presenter) to grasp the participants' reactions for each page after the event. Such information on participants' reactions for each page is not obtainable by using questionnaires received from participants. Furthermore, the information enables a user (e.g., presenter) to identify pages for which participants' reactions are not good, which helps the user find problems in description in and/or explanation for the material.

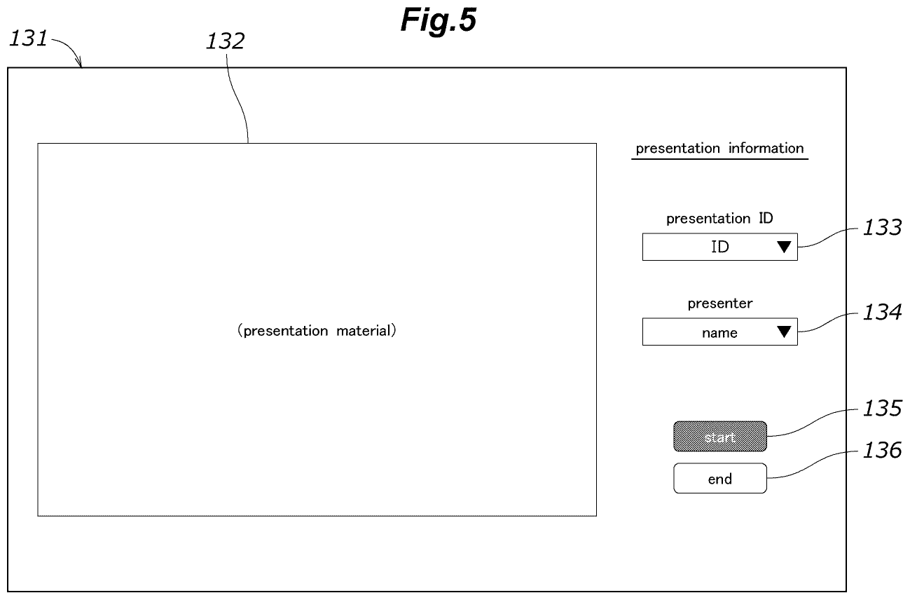

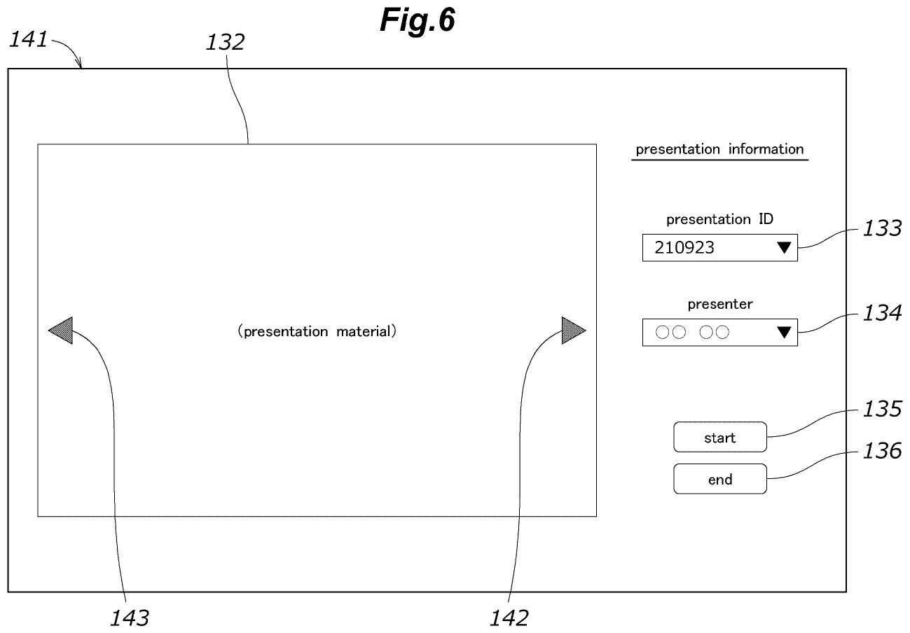

Next, presentation screens displayed on a user terminal 2 of a presenter (host) will be described. FIGS. 5 and 6 are explanatory diagrams showing presentation screens 131 and 141 on a user terminal 2 of a presenter (host).

When a presenter (host) starts a presentation, the user terminal 2 of the presenter displays a presentation screen 131 (initial screen) shown in FIG. 5.

The presentation screen 131 shown in FIG. 5 includes a document display section 132. The document display section 132 displays a presentation material that the host can share with participants.

The presentation screen 131 includes a presentation ID entry field 133 and a presenter name entry field 134. The presenter can input a presentation ID by entering texts or selecting from a pull-down menu in the presentation ID entry field 133. The presenter can input the presenter's name by entering texts or selecting from a pull-down menu in the presenter name entry field 134. In some cases, a presentation ID may be automatically assigned and notified to a presenter when the presenter registers a presentation material in the analysis server 1 before the presentation.

The presentation screen 131 includes a start button 135 and an end button 136. The presenter operates the start button 135 when starting a presentation. The presenter also operates the end button 136 when the presentation ends. These operations allow the analysis server 1 to acquire a presentation duration (start-to-end time).

Furthermore, when the presenter operates the start button 135 in the presentation screen 131 (FIG. 5), the screen transitions to the presentation screen 141 shown in FIG. 6.

As shown in FIG. 6, the presentation screen 141 includes a page advance button 142 and a page return button 143 in the document display section 132. When the presenter operates the page advance button 142, the presentation material displayed in the document display section 132 goes to the next page. When the presenter operates the page return button 143, the presentation material displayed in the document display section 132 returns to the previous page. These operations on the buttons allow the analysis server 1 to acquire a page display time (start-to-end time) for each page.

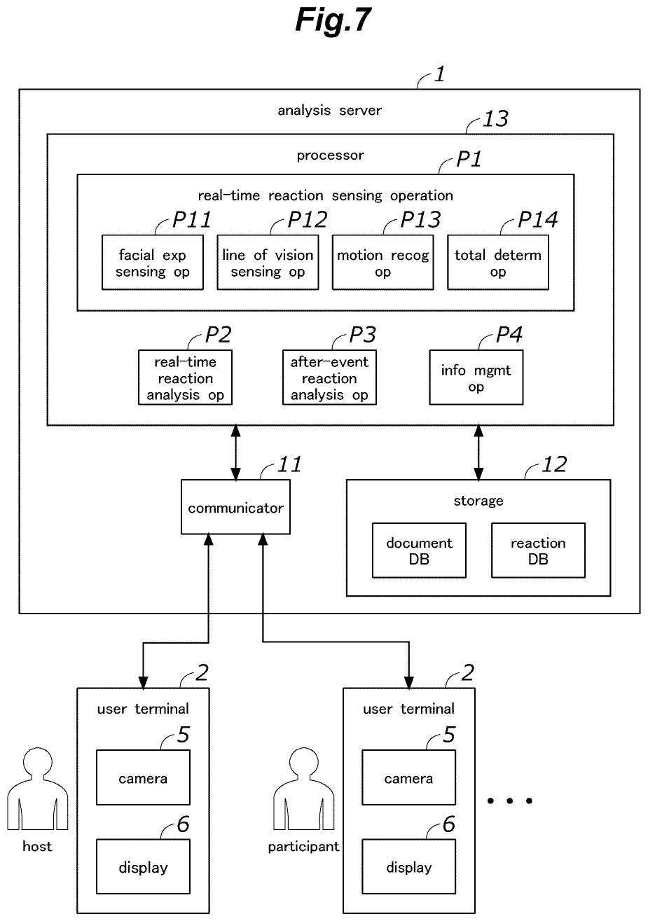

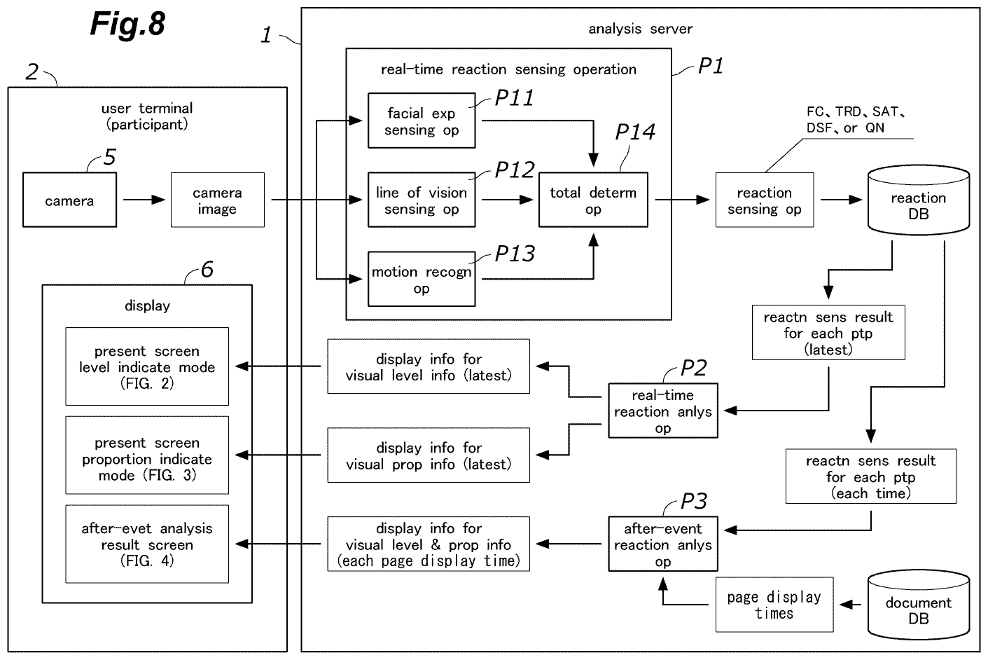

Next, a schematic configuration of an analysis server 1 will be described. FIG. 7 is a block diagram showing a schematic configuration of the analysis server 1. FIG. 8 is a block diagram showing an outline of operations performed by the analysis server 1.

The analysis server 1 includes a communication device 11, a storage 12, and a processor 13.

The communication device 11 communicates with the host's user terminal 2 and participants' user terminals 2 via the network.

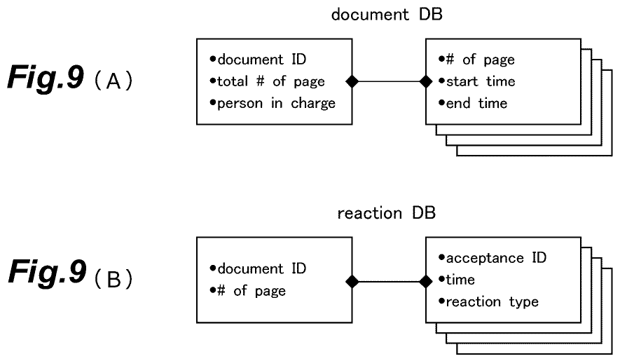

The storage 12 stores programs that are executable by the processor 13 and other information. In addition, the storage 12 stores registered information contained in a document database (document DB) and a reaction database (reaction DB) (FIG. 9).

The processor 13 performs various processing operations by executing programs stored in the storage 12. In the present embodiment, the processor 13 performs operations including a real-time reaction sensing operation P1, a real-time reaction analysis operation P2, an after-event reaction analysis operation P3, and an information management operation P4.

In the real-time reaction sensing operation P1, the processor 13 acquires camera images of each participant from the each participant's user terminal 2 and senses reactions shown by the each participant in real time based on the camera images. The real-time reaction sensing operation P1 involves a facial expression sensing operation P11, a line-of-vision sensing operation P12, a motion recognition operation P13, and a total determination operation P14.

In the facial expression sensing operation P11, the processor 13 senses a facial expression of a participant's face based on camera images.

In the line-of-vision sensing operation P12, the processor 13 senses a line-of-vision of a participant based on camera images.

In the motion recognition operation P13, the processor 13 recognizes a participant's motion based on camera images.

In the total determination operation P14, based on sensing operation results of the facial expression sensing operation P11 and the line-of-vision sensing operation P12 and a recognition result of the motion recognition operation P13, the processor 13 determines, as a reaction sensing operation result, which type of reaction is exhibited by a participant: among reactions indicating a focused state of mind (FC type reaction), a tired state of mind (TR type reaction), a satisfied state of mind (ST type reaction), a dissatisfied state of mind (DSF type reaction), and a questioning state of mind (QN type reaction).

For example, from the facial expressions sensed in the facial expression sensing operation P11, the processor 13 estimates whether the participant's emotion is positive, negative, or neutral, and based on the estimation result, the processor 13 determines the type of reaction, such as ST type reaction or DSF type reaction.

From the movement of a participant's line of vision sensed in the line-of-vision sensing operation P12, the processor 13 estimates the participant's focus level (concentration level). When the line of vision of the participant sensed in the line-of-vision sensing operation P12 is in the direction toward the display screen of the user terminal 2, the processor 13 estimates that the participant is gazing at the display screen. When the line of vision of the participant is not in the direction toward the display screen, the processor 13 estimates that the participant is looking away from the display. Based on these estimation results, the processor 13 determines the type of reaction such as FC type reaction or TRD type reaction.

Based on a participant's body motion and posture sensed in the motion recognition operation P13, the processor 13 determines that the reaction type is TRD type. When a participant's nodding motion is sensed in the motion recognition operation P13, the processor 13 determines that the reaction type is SAT type. When a participant's head tilting motion is sensed in the motion recognition operation P13, the processor 13 determines that the reaction type is QN type.

In the present embodiment, the processor 13 determines, as the reaction sensing operation result, the type of reaction selected from reactions indicating a focused state of mind (FC type reaction), a tired state of mind (TR type reaction), a satisfied state of mind (ST type reaction), a dissatisfied state of mind (DSF type reaction), and a questioning state of mind (QN type reaction). However, other types of reactions may be defined and included in the reaction sensing operation results. For example, when it is difficult to determine a participant's reaction type as any of the five reaction types, the type of reaction may be determined as a reaction indicating no response of mind (NO type reaction).

In real-time reaction analysis operation P2, the processor 13 acquires a latest reaction sensing operation result (reaction type) determined in the reaction sensing operation P1 for each participant, and aggregates the latest reaction sensing operation results for all the participants to generate reaction information for all the participants. Then, the processor 13 visualizes the generated reaction information to provide visualized reaction information as display information.

More specifically, the processor 13 generates level information (reaction level) indicating the proportion of participants showing positive reactions to all the participants, to provide visualized level information (reaction level) as display information. The level information indicates the percentage of the number of participants showing the positive reactions relative to the number of all the participants. The display information is an image 106 indicating the reaction level and displayed in the analysis result display section 105 of the presentation screen 101 (FIG. 2) in the level display mode.

The processor 13 generates proportion information about proportions of participants showing reactions of respective types and visualizes the proration information to provide visualized proportion information as display information. The proportion information indicates the percentage of the number of participants for each reaction type to the number of all the participants as 100 percent. The display information is an image 112 indicating the reaction proportions and displayed in the analysis result display section 105 of the presentation screen 111 (FIG. 3) in the proportion display mode.

In the after-event reaction analysis operation P3, from the information records acquired in the reaction sensing operation P1 and registered in the reaction DB, the processor 13 extracts, for each of the participants, reaction sensing operation results, each acquired at each time to sense a reaction shown by the participant, over the entire time during an online meeting (presentation), and aggregates the acquired reaction sensing operation results to generate reaction information for each stage of the online meeting. Then, the processor 13 visualizes the generated reaction information for each stage to provide visualized reaction information for the each stage as display information.

When the subject online meeting (online event) is a presentation, each stage of the online meeting corresponds to a time during which each page (slide) of a presentation material is displayed and explained by a presenter; that is, each page display time (a start-to-end time for each page). Each page display time is acquired from the document DB. In addition, the processor 13 generates bar graphs representing how the participants' reactions change across the respective page display times.

Specifically, for each page display time, the processor 13 generates level information; that is, information about the percentage of participants showing positive reactions to all the participants. Then, the processor 13 visualizes the level information for the each page display time to provide visualized level information as display information. The level information is displayed as a line graph 123 in the after-event analysis result screen 121 (FIG. 4) displayed on a participant's user terminal 2.

Furthermore, for each page display time, the processor 13 generates proportion information; that is, information about the respective proportions of participants showing different reaction types to all the participants. Then, the processor 13 visualizes the proportion information for the each page display time to provide visualized proportion information as display information. The proportion information is displayed as bar graphs 122 in the after-event analysis result screen 121 (FIG. 4) displayed on a participant's user terminal 2.

When aggregating reaction sensing operation results for each participant to thereby generate reaction information for each stage of an online meeting, the processor 13 generates reaction information for the each stage by statistically processing (e.g., averaging) records of reaction information (level information and proportion information) for the stage; that is, reaction information records included in a corresponding page display time.

In the information management operation P4, the processor 13 manages the document DB containing registered information about documents (presentation materials) used in online meetings. In the information management operation, the processor 13 also manages the reaction DB containing information records about reactions shown by participants in online meetings (presentations). Registered information records contained in the document DB and the reaction DB are stored in the storage 12.

The facial expression sensing operation, line-of-vision sensing operation, and motion recognition operation may be performed with machine learning models (image recognition engines) trained by using machine learning technologies such as deep learning. The total determination operation may also be performed with a machine learning model trained by using machine learning technologies such as deep learning.

Next, registered information contained in the document DB and the reaction DB, both being managed by the analysis server 1 will be described. FIG. 9 is an explanatory diagram showing registered information contained in the document DB and the reaction DB.

In the analysis server 1, the document DB manages documents shared between the presenter (host) and participants in an online meeting (presentation). Specifically, the document DB manages information about presentation materials.

As shown in FIG. 9(A), the document DB contains, for each registered presentation, the document ID (presentation ID) of a presentation material, the total number of pages of the presentation material, and the presenter's name. The document DB also contains, for each presentation material, information on each page of the presentation material, including the page number and a page display time (start-to-end time).

In the analysis server 1, the reaction DB manages information about reactions shown by participants in an online meeting.

As shown in FIG. 9(B), the reaction DB contains, for each registered presentation, information on a registered online meeting (presentation), including the document ID (presentation ID) and the number of each page of a presentation material. The reaction DB also contains, for each registered participant in an online meeting, information about reaction sensing operations, including the acceptance ID for the each participant, times at which the reaction sensing operations were performed, and reaction sensing operation results (types of reactions).

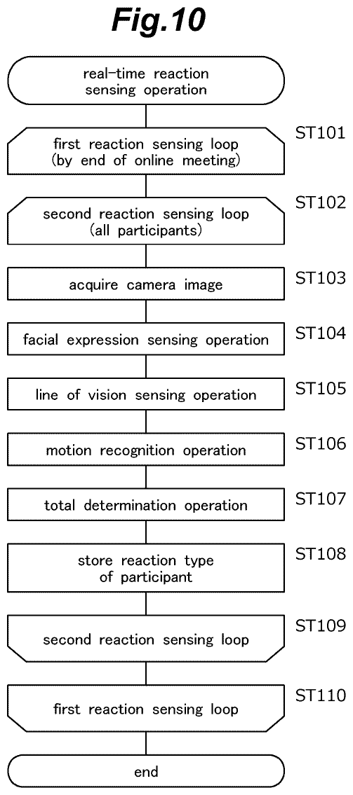

Next, the real-time reaction sensing operation performed by the analysis server 1 will be described. FIG. 10 is a flow chart showing a procedure of the real-time reaction sensing operation.

The analysis server 1 performs the real-time reaction sensing operation. The analysis server 1 repeatedly performs, for each participant of all the participants, reaction sensing operations, each performed at each time to sense a reaction shown by the each participant, over the entire time during an online meeting (presentation).

More specifically, the analysis server 1 repeats the operations of the steps of a first reaction sensing loop (ST101-ST110). The analysis server 1 periodically repeats the operations of the steps of the first reaction sensing loop over a time period of the online meeting; that is, until the end of the online meeting (presentation).

In the second reaction sensing loop, the analysis server 1 repeats the operations of the steps of a second reaction sensing loop (ST102 to ST109). For each participant, the analysis server 1 repeatedly performs the operations of the steps of the second reaction sensing loop, until the operations are completed for all the participants in the online meeting.

In the second reaction sensing loop, for each of all the participants, the analysis server 1 first acquires a camera image from a user terminal 2 of the each participant (ST103). The user terminal 2 may be configured to detect the participant's head in the camera image, and then extract a face image from the camera image so that the analysis server 1 can acquire the extracted face image. This configuration decreases the amount of image data the analysis server 1 needs to acquire from user terminals 2 via the network, thereby reducing a load on the network and allowing the system to efficiently perform the subsequent operations.

Next, the analysis server 1 senses a facial expression of the participant's face based on the camera image (facial expression sensing operation) (ST104).

The analysis server 1 also senses a line-of-vision of the participant based on the camera image (line-of-vision sensing operation) (ST105).

Furthermore, the analysis server 1 also recognizes a motion of the participant based on the camera image (motion recognition operation) (ST106).

Next, based on sensing operation results of the facial expression sensing operation and the line-of-vision sensing operation and a recognition result of the motion recognition operation, the analysis server 1 determines, as a reaction sensing operation result, which type of reaction is exhibited by the participant: among reactions indicating a focused state of mind (FC type reaction), a tired state of mind (TR type reaction), a satisfied state of mind (ST type reaction), a dissatisfied state of mind (DSF type reaction), and a questioning state of mind (QN type reaction) (total determination operation) (ST107).

Next, the analysis server 1 stores the reaction sensing operation result (type of reaction) of the participant in the storage 12 together with the current time (ST108).

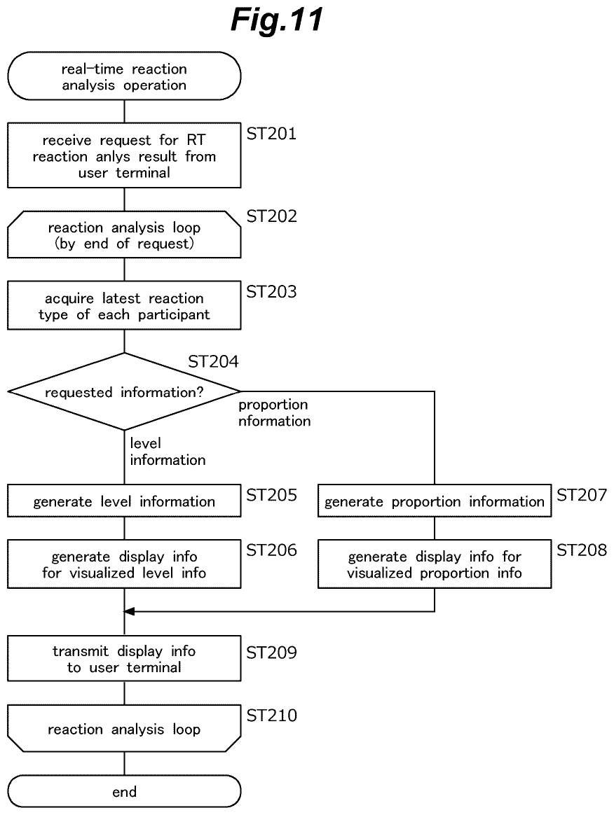

For each participant, the analysis server 1 repeats the above-described operations of the steps of the first and second reaction sensing loops over the time period of the online meeting; that is, until the end of the online meeting (presentation). As a result, reaction sensing operation results, each acquired at each time to sense a reaction shown by the each participant, are stored and accumulated in the storage 12 over the entire time during the online meeting. Next, a procedure of the real-time reaction analysis operation performed by the analysis server 1 will be described. FIG. 11 is a flow chart showing a procedure of the real-time reaction analysis operation.

Upon receiving a request for real-time reaction analysis results from a participant's user terminal 2 (ST201), the analysis server 1 initiates the operations of the steps of a reaction analysis loop (ST202-ST210). The analysis server 1 repeats the steps of the reaction analysis loop in a predetermined cycle until the request from the user terminal 2 is completed.

In the reaction analysis loop, the analysis server 1 first acquires a latest reaction sensing operation result (type of reaction) for each participant (ST203). Next, the analysis server 1 determines whether the information requested by the each participant's user terminal 2 is level information or proportion information (ST204).

When the user terminal 2 requests level information (“level information” in ST204), the analysis server 1 aggregates the latest reaction sensing operation results (types of reactions) for the respective participants to generate the latest level information; that is, information on the percentage of participants showing positive reactions to all the participants (ST205). Next, the analysis server 1 visualizes the generated level information to provide the visualized latest level information as display information (ST206).

When the user terminal 2 requests proportion information (“proportion information” in ST204), the analysis server 1 aggregates the latest reaction sensing operation results (types of reactions) for the respective participants to generate the latest proportion information; that is, information on proportions of the respective numbers of participants showing different types of reactions to that of all the participant (ST207). Next, the analysis server 1 visualizes the latest proportion information to provide the visualized latest proportion information as display information (ST208).

Next, the analysis server 1 transmits the requested information; that is, the visualized latest level information or proportion information to the user terminal 2 (ST209). As a result, the user terminal 2 displays an image 106 indicating the latest reaction level or an image 112 indicating the latest reaction proportions, in the analysis result display section 105 of a corresponding one of the presentation screen 101 (FIG. 2) or the presentation screen 111 (FIG. 3).

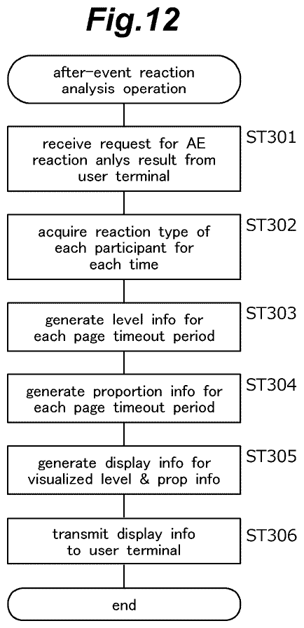

Next, a procedure of the after-event reaction analysis operation performed by the analysis server 1 will be described. FIG. 12 is a flow chart showing a procedure of the after-event reaction analysis operation.

Upon receiving a request for after-event reaction analysis operation results from a participant's user terminal 2 (ST301), the analysis server 1 acquires respective reaction sensing operation results for each of all the participants in a presentation (online meeting), each result acquired at each time to sense a reaction shown by, from the reaction DB (FIG. 9(B)) (ST302).

Next, the analysis server 1 aggregates, for each participant, reaction sensing operation results, each acquired at each time to sense a reaction shown by the participant, to generate level information (reaction information) for each page display time (from start time to end time); that is, information about the percentage of participants showing positive reactions to all the participants (ST303).

In addition, the analysis server 1 aggregates, for each participant, the reaction sensing operation results, each acquired at each time to sense a reaction shown by the each participant, to generate proportion information (reaction information) for each page display time; that is, information about proportions of the respective numbers of participants showing different types of reactions (FC type, TR type, ST type, DSF type or QN type reaction), to that of all the participants (ST304).

Next, the analysis server 1 visualizes the generated level information and proportion information for each page display time, to provide the visualized level information and the visualized proportion information as display information (ST305).

Next, the analysis server 1 transmits the visualized level information and the visualized proportion information to the user terminal 2 (ST306). As a result, the user terminal 2 displays bar graphs 122 and a line graph 123 in the after-event analysis result screen 121 (FIG. 4).

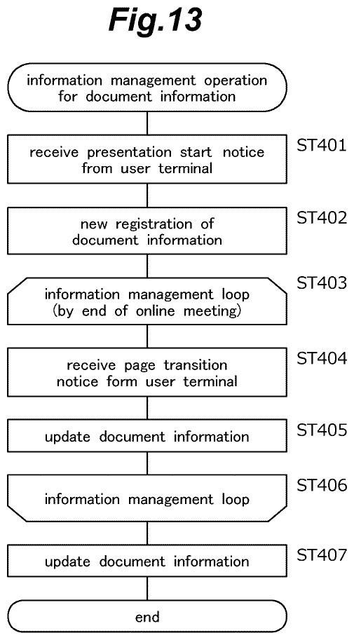

Next, a procedure of the information management operation for the document DB, performed by the analysis server 1, will be described. FIG. 13 is a flow chart showing a procedure of the information management operation for the document DB.

The analysis server 1 manages the document DB (FIG. 9(A)) containing registered information about documents (presentation materials) used in online meetings (information management operation). A presenter (host) operates on the presentation screens 131 and 141 displayed on the presenter's user terminal 2, to enter a document ID (presentation ID) and the presenter's name, to start the presentation, to cause a presentation material to go to the next page or another page, and to end the presentation. The analysis server 1 performs the information management operation based on notices (instruction notices), transmitted from the user terminal 2 in response to the presenter's operations.

Specifically, upon receiving a presentation start notice transmitted from the presenter's user terminal 2 (ST401), the analysis server 1 sets the time at which it receives the notice, as a start time of the first page of a presentation material, and registers a new document for this presentation in the document DB (ST402).

Next, the analysis server 1 starts operations of the steps of an information management loop (ST403-ST406), and periodically repeats the operations until the end of the present online meeting (presentation).

In the information management loop, upon receiving a page transition notice from the user terminal 2 (ST404), the analysis server 1 sets the time at which it receives the notice, as an end time of the current page and also as a start time of a new page to which the page transitions, and updates registered information for the present presentation in the document DB (ST405).

The analysis server 1 repeats the operations of the steps of the information management loop until the present presentation ends; that is, until it receives an end-of-presentation notice from the user terminal 2.

Next, the analysis server 1 sets the time at which it receives the end-of-presentation notice from the user terminal 2, as an end time of the last page, to update the registered information in the document DB regarding the present presentation (ST407).

In the present embodiment, the reaction detection system is configured such that the analysis server 1 acquires camera images of a participant from the participant's user terminals 2 and performs the image analysis operation on the camera images to sense reactions shown by the participant. In other embodiments, the reaction detection system may be configured such that a user terminal 2, which acquires camera images of a participant, performs the image analysis operation on the camera images, and then transmits a result of the reaction sensing operation to the server device where reaction sensing operation results are accumulated in the reaction DB.

While specific embodiments of the present disclosure are described herein for illustrative purposes, the present disclosure is not limited to the specific embodiments. It will be understood that various changes, substitutions, additions, and omissions may be made for elements s of the embodiments without departing from the scope of the invention. In addition, elements and features of the different embodiments may be combined with each other as appropriate to yield an embodiment which is within the scope of the present disclosure.

### INDUSTRIAL APPLICABILITY

A reaction sensing system and a method for displaying reaction sensing result according to the present disclosure are configured to present reactions exhibited by participants in an online event to users such that individual participants are not identified, thereby preventing the participants from being conscious that their reactions are being sensed, and thus enabling them to naturally exhibit their reactions, which allows the users to acquire information on the participants' naturally-exhibited reactions, and are useful as a reaction sensing system and a method for displaying reaction sensing result configured to sense reactions exhibited by participants in an online event, visualize results of sensing, and display the visualized results of sensing.

### Glossary

1 analysis server (server device, information processing device)
2 user terminal (terminal device)
5 camera
6 display
11 communication device
12 storage
13 processor

1. A reaction sensing system configured to sense reactions exhibited by participants in an online event, visualize results of sensing, and display the visualized results of sensing, the system comprising:
a terminal device having a camera for shooting each of the participants; and
a server device configured to acquire camera images of each participant from the terminal device, perform a reaction sensing operation to sense reactions exhibited by the each participant based on the acquired camera images, and generate display information that visualizes results of the reaction sensing operation,
wherein the server device generates reaction information on reactions exhibited by all the participants by aggregating the respective results of the reaction sensing operation for all the participants, and generates the display information that visualizes the reaction information.

2. The reaction sensing system as claimed in claim 1, wherein the server device generates the display information based on the respective results of the reaction sensing operation for the participants, the respective results of the reaction sensing operation being provided on a real time basis.

3. The reaction sensing system as claimed in claim 2, wherein the server device generates, as the reaction information, level information indicating a percentage of positive or negative reactions exhibited by all the participants.

4. The reaction sensing system as claimed in claim 2, wherein the server device generates, as the reaction information, proportion information indicating proportions of the respective numbers of participants exhibiting different types of reactions to that of all the participants.

5. The reaction sensing system as claimed in claim 1, wherein, after the online event is finished, the server device generates, as the reaction information, a graph indicating how the reactions exhibited by the participants change across different stages of the online event.

6. The reaction sensing system as claimed in claim 1, wherein the server device generates, as the results of the reaction sensing operation, results of determination of which type of reaction is exhibited by the each participant: among the types of reactions indicating a focused state of mind, a tired state of mind, a satisfied state of mind, a dissatisfied state of mind, and a questioning state of mind.

7. A method for displaying reaction sensing result by sensing reactions exhibited by participants in an online event, visualizing results of sensing, and displaying the visualized results of sensing, the method comprising:
acquiring camera images of each participant from a terminal device having a camera, the camera images being shot by the camera;
performing a reaction sensing operation to sense reactions exhibited by the each participant based on the acquired camera images;
generating reaction information on reactions exhibited by all the participants by aggregating the respective results of the reaction sensing operation for all the participants; and
generates display information that visualizes the reaction information.
